(19) United States
(12) Patent Application Publication
(10) Pub. No.: US 2008/0025723 A1
(43) Pub. Date: Jan. 31, 2008

(54) System and method for creating cheap efficient high-speed home networks.

(76) Inventors: Yaron Mayer, Jerusalem (IL); Haim Gadassi, Jerusalem (IL)

Correspondence Address: YARON MAYER, 21 AHAD HAAM ST., JERUSALEM, 92151, IL

(21) Appl. No.: 11/739,001

(22) Filed: Apr. 23, 2007

(30) Foreign Application Priority Data
Apr. 21, 2006 (GB) 0607828.1
Dec. 27, 2006 (GB) 0625693.7

(51) Int. Cl. H04J 14/00; H04B 10/20

(52) U.S. Cl. 398/58

(57) ABSTRACT

Broadband connections of end users to the Internet are becoming more and more common today, and the most common types of these fast connections are ADSL and Cable modems. These connections are typically still very slow compared to the speeds that are expected in the next few years and typically also highly asymmetric and allow typically 750-2000 Kbit per second (most typically 1500 Kbit) for the downlink and typically for example 96 Kbit or 128 Kbit per second for the uplink (although standard ADSL can in principle support up to 8 Mbit per second download speed and up to 800 Kbit per second upload speed), based on the assumption that most users download much more data than they upload. However, for many users these limitations are highly undesirable, and these are for example home users or small businesses or organizations who want to use the connection also for example for VOIP (voice over IP) communications and/or Video-over IP communications and/or conferences and/or for example running web servers and/or for example various p2p applications, and in fact the low uplink also many times slows down the downlink due to the overhead needed for dealing with relatively small packets, so that any additional uplink by the user can severely limit the real downlink that can be achieved below the downlink bandwidth which the user is paying for. Actually ADSL is beginning to be replaced in some places by VDSL where the distance to the nearest street switchboard is about 1.2 Kilometers or less, which in principle allows up to 52 Mbit per second Download speed and up to 16 Mbit per Second Upload speed. However, these modems are expensive and are only slowly entering the market and only in a few countries. On the other hand there is no need to upgrade typical cable modems for enabling faster speeds, such as for example 20 Mbit downlink and 2 Mbit uplink, as is offered for example in France, when the ISPs start offering such speeds—since the typical common cable modem is already capable of such speeds. The present invention enables an improved Ethernet-over-coax solution which enables using one or a few very high speed modems, each for multiple users or apartments, preferably in combination with very cheap and very fast home networks (offering preferably at least up to 100 Mbit per second for each computer, preferably at full duplex), preferably based on the Cable TV coax cables, so that multiple computers can share the same internet connection for example in the same apartment and/or communicate between themselves. This preferably includes using a different frequency for the Ethernet-over coax channel for each computer in the apartment. Also shown are for example improved home networks using the second set of normally unused 2 phone wires and for example some improvement in HPNA networks, such as for example using HPNA also to connect between the street switchboard and the home or office instead of having to use also for example an ADSL or VDSL modem.

This patent application claims priority from British application 0607828.1 of Apr. 21, 2006 and from British application 0625693.7 of Dec. 27, 2006, hereby incorporated by reference in their entireties.

### BACKGROUND OF THE INVENTION

1. Field of the Invention

The present invention relates to creating cheap efficient high-speed home networks, and more specifically to an improved Ethernet-over-coax solution which enables using one or a few very high speed modems each for multiple users or apartments, preferably in combination with very cheap and very fast home networks, preferably based on the Cable TV coax cables, and preferably with a different frequency over the coax for the Ethernet communications of each end socket in the apartment or at least each computer.

2. Background

Broadband connections of end users to the Internet are becoming more and more common today, and the most common types of these fast connections are ADSL and Cable modems. These connections are typically still very slow compared to the speeds that are expected in the next few years and typically also highly asymmetric and allow typically 750-2000 Kbit per second (most typically 1500 Kbit) for the downlink and typically for example 96 Kbit or 128 Kbit per second for the uplink (although standard ADSL can in principle support up to 8 Mbit per second download speed and up to 800 Kbit per second upload speed), based on the assumption that most users download much more data than they upload. However, for many users these limitations are highly undesirable, and these are for example home users or small businesses or organizations who want to use the connection also for example for VOIP (voice over IP) communications and/or Video-over IP communications and/or conferences and/or for example running web servers and/or for example various p2p applications, and in fact the low uplink also many times slows down the downlink due to the overhead needed for dealing with relatively small packets, so that any additional uplink by the user can severely limit the real downlink that can be achieved below the downlink bandwidth which the user is paying for. Actually ADSL is beginning to be replaced in some places by VDSL where the distance to the nearest street switchboard is about 1.2 Kilometers or less, which in principle allows up to 52 Mbit per second Download speed and up to 16 Mbit per Second Upload speed. However, these modems are expensive and are only slowly entering the market and only in a few countries. A typical ADSL modem which can download at up to 8 Mbps and upload up to 1 Mbps currently costs around $10 (internal PCI card) or $30 (external). A VDSL modem with download speed of up to 15 Mbps currently costs around $70, and a full-speed VDSL modem with download speed of up to 52 Mbps and upload up to 16 Mbps currently costs around $135. On the other hand there is no need to upgrade typical cable modems for enabling faster speeds, such as for example 20 Mbit downlink and 2 Mbit uplink, as is offered for example in France, when the ISPs start offering such speeds—since the typical common cable modem is already capable of such speeds: For example in Israel most Cable modem subscribers were typically already given by the Cable company a Thomson TCM 305 cable modem or Motorola SB4200 cable modem, which are capable of download speed up to 27 Mbps (with 64 QAM) or 38 Mbps (with 256 QAM) and upload of up to 5 Mbps (QPSK) or 10 Mbps (QAM), while using a single 6 MHz channel. A typical Cable modem capable of up to 42.88 Mbps download and up to 10.24 Mbps upload currently costs around $60. However, since in a few years many users will be offered up to 100 Mbps or even 1 Gbps, smarter solutions are needed for the following years, and in some countries this is already beginning to be available: According to http://www.hearusnow.org/fileadmin/sitecontent/broadband_report_optimzed.pdf, in Japan for example there are already many users which have download speeds of 26 mbps and some even 100 mbps with some DSL connections, and already there are even some Japanese users with FTTH (Optic Fiber to the Home) which have already 1 Gbps. According to http://money.cnn.com/magazines/business2/business2_archive/2006/01/01/8368133/index.htm. in Hong Kong for example a company called City Telecom offers 100 megabits per second for just $25 a month, and according to http://comment.silicon.com/simonmoores/0,3800005547,39128134,00.htm, in Hong Kong also 1 GB broadband will be already available this year, and according to http://en.wikipedia.org/wiki/Broadband_Internet_access for example in Sweden since October 2005 users can get symmetric 100 Mbps for $40 per month, and one service there even offers 1 Gbit/s connections. However for example Israel and the US the typical download speed of ADSL does not exceed 1.5 Mbps with upload speed of 96 or 128 kbps (or sometimes 256) and the typical download speed of Cable is 1.5-4 (sometimes 5) Mbps with upload of 128-384 (or sometimes 512), and according to http://en.wikipedia.org/wiki/DSL_around_the_world, in many European countries the situation is somewhere in between: for example 10 Mbps available in England, 12 Mbps available in Finland, 6 and even 16 Mbps available in Germany, 10 Mbps available in some places in Italy, etc. Therefore smarter solutions are needed for cheaper and faster upgrading of users to speeds of up to 100 Mbps or even 1 Gbps even without FTTH.

Although there are already two Ethernet-over-Coax solutions—by the Finish company Seleste and by American company Narad, they apparently use the same Ethernet frequency for all nodes. The Seleste solution apparently uses a separate Coax cable for each end-node (typically a whole apartment) but offers each computer a symmetric connection of only up to 10 Mbit per second. The Narad solution uses also separate additional communication channels (such as for example optic fiber) between the switchboard at the bottom of the building and the typical Optical end-node of the cable network, which typically connects to about 2000 apartments through coax cable.

In addition, typically both home users and businesses have more than one computer in the same apartment and can save a lot of money by sharing fast internet connections between more than one computer (for example it is much cheaper and efficient to pay for a single internet broadband connection of for example 3 Mbit per second and share it between two computer than to buy two separate broadband connections of 1.5 Mbit per second, on condition that the connection has sufficient uplink), however using cable connections typically means either laying ugly wires between rooms or having to move wires through existing wall canals (which don't always have sufficient room left). On the other hand, wireless networks are more expensive, and are typically limited in bandwidth for example in Security concrete-wall rooms (MAMAD) or due to cross-talk for example with the wireless networks of the neighbors, which creates automatic negotiations and more limited bandwidth left for each apartment, and also they are much more exposed to possible bandwidth theft by free riders and/or data theft, even when various encryptions are used. It is also possible for example to build a home network using existing phone connections in the apartment and for example the new HPNA standard 3.0 allows transferring 128 Mbps and can be increased even to 240 Mbps, however this is bandwidth is shared between the various devices that connect to the line and for example each USB to HPNA 2.0 adapter (which is only 10 Mbps) costs around $20-30. Therefore a smart solution is needed which also enables building cheap internal networks with speeds preferably up to 100 Mbps per computer or even more, preferably based on the same coax cables which already exist, and preferably with a price of $10 or less per computer. This will become extremely important as uses start receiving speeds of 100 Mps or more, since at such speeds the incentive for sharing the connection between more than one computer in the apartment becomes very attractive, and especially in places where such connections will remain more expensive, such as for example in rural areas.

### SUMMARY OF THE INVENTION

The present invention enables an improved Ethernet-over-coax solution which enables using one or a few very high speed modems, each communicating with multiple apartments, preferably in combination with very cheap home networks preferably based on the Cable TV coax cables, and preferably with a different frequency for the Ethernet-over coax channel of each end socket in the apartment. Preferably the Ethernet-over-Coax is implemented by using at each end socket a frequency up-shifter which preferably shifts Ethernet communications preferably to above the frequency range used by the Cable TV network (typically the Cable TV uses the frequencies up to 860 Mhz, so the range above that until about 2 Giga can be used for the network communications) for sending data, and a similar frequency down-shifter that preferably shifts the frequency of received data back to the range of normal Ethernet communications (about 100 Mhz). Preferably there are one or more routers and/or hubs for example at the bottom floor of the building which each communicate with multiple apartments (preferably with one coax cable per apartment, but preferably an apartment can also get more than one coax cable if needed), and preferably this router and/or hub takes care of implementing the separate frequency channels by using preferably frequency shifters for each of the needed frequencies (preferably at least 5-6 separate frequencies for each coax cable, since each Ethernet channel might need up to 200 MB in order to reach up to 100 Mbit per second, or around 10 separate frequencies each using about 100 MB, by preferably keeping the same width of 100 MB which the standard 100 MB Ethernet card uses, which means adding more electronics to the shifters), and/or for example there is such a router and/or hub in each apartment, and preferably all the communications between computers connected to these Ethernet end sockets go through the router and/or hub. Preferably the routers and/or hubs themselves deal directly with Ethernet TCP/IP packets and preferably the frequency shifters are coupled to them. (Another possible variation is the shifters are for example within the router and/or the router can for example deal directly with the signals at the higher frequencies, but that is less preferable). By using a different frequency for each end socket, each end socket can preferably get the full Ethernet bandwidth without having to add a separate coax cable for each end-node, so that for example if two computers communicate data between themselves for example at 100 Mbit per second, this does not degrade the Internet performance of any other computer in the apartment at the same time. If for example the two computers which are communicating between themselves, or at least one of them, want to also for example download data from the Internet at the same time, then preferably the bandwidth is split, preferably by a bandwidth management software and/or for example by the router, between the Internet connection and the computer-to-computer connection, in a ratio that can preferably be determined for example by the user and/or for example automatically, or for example the user can add more than one Ethernet card to the computer and preferably connect the second card to a socket with a different frequency, to enable full speed both for the internet connection and for the local communication at the same time. In addition, preferably this solution can also be applied for example for creating a very cheap and fast home network, even independently of the adoption of the solution by the ISPs, so that for example one or more computers in the same apartment can share the same Internet connection and/or can communicate data between themselves preferably at full Ethernet speeds. This can work for example in combination with one or more ADSL or DSL modem or VDSL modem or cable modem or for example an optic fiber end unit or for example a free-air optic unit, so that for example preferably one such preferably very fast unit enters the apartment and more than one computer share it. Preferably there can be one or more end sockets in each room (and/or for example at least one or some of the socket boxes contain more than one Ethernet end-socket), so that for example a printer or other peripheral devices can also be connected to the same socket in the same room where a computer is also connected to the network. If more than 5 or 6 end sockets are needed in a single apartment then preferably either more than 1 coax cable is connected to that apartment, or for example some of the end devices share the same frequency, which means that at peak load the bandwidth per device might be reduced, but that is no problem since 100 Mbit per second is way beyond what most ISPs currently offer users, and even when ISPs start offering for example a 100 Mbit per second internet connection per computer, sharing this for example with a printer will not cause a significant degradation in Internet speed because printing is done only once in a while in short bursts of data transfer and typically involves relatively smalls amount of data. Preferably the users can also add for example a socket splitter where needed, which preferably simply plugs into an end node Ethernet socket and converts it into two sockets (preferably still using the same frequency, or for example the additional socket can create an additional shift in the frequency, thus actually becoming a socket of a different frequency). Another possible variation is that for example at least some sockets have a dynamically selectable frequency, for example by using a crystal which can electronically be made to change its frequency for example by turning a button or for example changing the position of a switch or for example adding or removing or moving some jumper. Preferably the system allows up to 100 Mbit in full-duplex, preferably for example by using differentiation calculation of the voltages (i.e. preferably by using additive voltages for the transmission), in order to enable signals to be sent in both directions at the same time. Of course various combinations of the above or other variations are also possible.

If the solution is based on one or more multi-apartment routers and/or hubs for example at the bottom of the building (or for example the basement) then preferably filters and/or multiplexers are added to create a separate coax link for each apartment without cross talks between the apartments. If the solution is implemented as a separate home-network without a central router at the building, then preferably a filter is added for each apartment, preferably at the entrance to the apartment. Another possible variation for example in separate independent home networks is for example to use only one frequency, but that is of course less efficient since the bandwidth of for example 100 Mbps becomes shared between the various computers (which is especially problematic if some computers also share data between themselves), unless for example each room (or at least some of the rooms) preferably has a separate coax cable so that for example the coax cables of different rooms all connect to the central hub or router for example at the entrance to the apartment, thus forming for example the shape of a root or tree. Of course this solution of separate coax cable for at least some of the rooms can be used also in combination with the separate frequencies to get even more speed, if for example the Internet connection is more than 100 mbps, such as for example 1 Gbps or more. If this is a standalone home network (i.e. without the shared building unit), preferably the network (preferably either with the single frequency or the multiple frequencies) preferably uses for example a hub or router, which is preferably coupled to the Internet modem (which can be for example a Cable modem, ADSL, VDSL, ONU Optical End Unit, or other means), or for example a modem is used which contains the router and/or hub within it, or for example the network is configured so that one of the computers acts as a server (preferably by adding an additional Ethernet network card to it so that one card is connected to the Internet and the other card is connected to the other computers in the network), thus saving also the router. (However in the single frequency solution preferably a router is used without the need for the hub because the router can connect to the coax with a single connection). If multiple frequencies are used then if a server is used instead of the router then preferably a separate Ethernet card is added to the server for each frequency (so that preferably each frequency behaves like a separate subnet and the server creates the connection between these subnets), and/or for example the Ethernet cards are improved so that a single card can have more than one socket, thus making the card itself behave for example like a hub. Alternatively, if the multiple frequencies are used together with a router, it means that in the stand-alone home network (or for example in the variation of the building network where a router is also used in the apartment for example for the communication between computers within the apartment), the router/hub preferably has sufficient sockets, one for each frequency (in which case for example the router is preferably connected for example through a few short Ethernet Cables to a multi-socket with an Ethernet socket for each of the frequencies), or for example the router connects with the filters directly to the Coax cable without the need for sockets (for example the filters can be integrated in the router's envelope), or for example even in this variation the router preferably has also one or more additional external sockets, which can for example connect additional nearby devices. Preferably the different frequency sockets are sold in different colors and/or other preferably conspicuous visual indicator, each color for a different frequency (or for example all sockets are white or similar colors or other common colors and the frequency is marked for example by a smaller color spot and/or for example by other markings and/or by numbers), so that the user can easily decide for example which sockets will share the same frequency and which will have a different frequency without getting confused between the rooms. If some people still prefer the single frequency solution in order to save some installation costs, then preferably different frequencies are distributed to different users, so that if afterwards they decide to upgrade, preferably they can return some of their single frequency sockets and get instead sockets with different frequencies (if all such users got the same single frequency and then wanted to upgrade then there would be a problem what to do with too many sockets of the same single frequency, whereas a good frequency spread between the users can mean simply for example swapping sockets between users that want to upgrade and selling them the additional router). However, when the integrated building solution is applied (i.e. the solution with one or more shared routers which each handle multiple apartments), preferably all the apartments receive the multi-frequency solution, since the cost for the router is already included, and in this case preferably the installation of sockets in the apartments is preferably done by the infrastructure providers which installs the system in the building. On the other hand, when installing an independent home network without the integrated building solution, the installation can preferably either be done by sending a technician to the apartment, which is typically needed anyway for example if additional coax endpoints need to be added (for example if there are only 1 or two TV end nodes and the users need it in one or more additional rooms), or the users can install it themselves (typically when there are already sufficient coax TV socket end points). Preferably the end sockets are designed in one or more sizes which preferably fit the typical size of most coax end sockets (which typically each contains either just a TV socket or both a TV socket and a Radio socket), so that preferably the additional Ethernet socket does not increase the size of the plastic cover of the socket or at least the hole in the wall preferably does not have to be increased. Preferably the improved sockets which include also the Ethernet sockets are installed either by removing the exiting TV socket and replacing it, or by adding an element which connects to the given TV and/or radio socket so that preferably only the plastic cover need to be replaced, or for example the new socket is based on simply plugging a device over the existing TV socket (preferably without even having to open its plastic cover), for example similarly to the way that a socket splitter is added to an electricity socket, so that preferably the plug-in covers on one side the existing TV socket and on the other side reveals a new TV socket together with the Ethernet socket, preferably next to it. (In other words the socket might also look for example like an external small box). Preferably the frequency up-shifter and down-shifter are very cheap devices that can typically cost just for example 20-50 cent or a similar amount. For power supply preferably the frequency up-shifter and down-shifter preferably get their electrical power from the coax cable itself. This is preferably done for example by adding a DC with a preferably low voltage of for example around 3-5 volts to the coax cable. If it is a standalone home network then preferably the additional DC is added for example from a transformer connected to the wall near one of the endpoints so that the DC is preferably carried over also to the other endpoints by the coax cable, and in the integrated building solution the DC is preferably added by a device near the shared router or routers preferably at the bottom of the building. Of course various combinations of the above or other variations are also possible.

If the users want for example to be able to use at least one mobile computer in the house, then preferably they can plug into one or more of the end sockets for example a device which translates the Ethernet communication for example to wireless communication, however this is preferably done by optic wireless communications (for example by using infrared), or for example by using UWB, which is typically limited to a few meters range, since this is much safer in terms of being protected from outside espionage and avoiding bandwidth collisions with neighboring apartments, and this way preferably each wireless outlet preferably covers more or less only the room in which it is installed.

In addition, if the standalone home network variation is used (i.e. without the shared building router and modem) then preferably a filter (or filters) is added, preferably at the point where the coax cable enters the apartment, which preferably prevents the DC current and the frequencies of above the normal cable TV broadcasts (typically above 860 MHz) from going outside the apartment. If the integrated building solution is used, then preferably such filters are added between the system at the bottom of the building and the coax cable that enters the building—to prevents the DC current and the frequencies of above the normal cable TV broadcasts from going outside the building. Another possible variation is to add the additional router in the apartment even in the integrated building solution, so that packets communicating between computers within the apartment don't leave the apartment, since letting internal communications go through the building's routers exposes the user to security risks for example in case someone taps into the lines in the stairway or into the shared routers of the building. In this case preferably the filter of signals above the Cable TV broadcasts is also added at the apartment preferably between the apartment and the rest of the building (preferably at the entrance to the apartment), so that preferably only the router of the apartment can enable packets of data on the network to move in or out of the apartment, and so preferably on both sides of this router separate up-shifters and down-shifters are used for each side of the coax cable (outside the apartment and inside of it). Another possible variation is that for example data encryption is preferably automatically added for example (preferably by the communications software on each of the communicating computers) when computers in the apartments communicate which each other, so that the shared building router can also be used for this communication without the need to add the additional router inside the apartment, eventhough it is still less safe than preventing altogether access to the data outside the apartment. This is preferably done by the user defining for example the IP addresses (and/or for example preferably some other hardware identifying codes) of the computers which are considered to be part of the internal apartment network, so that the relevant communication software on each of these computers knows which communications to encrypt and decrypt automatically, and/or for example the shared building router can automatically send this info to the computers in each apartment (for example according to the coax cable that goes into it, so that the user does not have to feed this information manually for example when installing the network), but this is less safe since it means that a hacker tempering with the shared building router might send misleading information to the computers in the apartment about the other computers in the internal apartment network, thus causing the encryption to be removed.

Preferably the shared building router or routers are coupled for example to one or more high speed cable modems which can preferably communicate for example at the speed of 2 or 3 or more Gigabit per second with the optical end node that typically services about 2000 users (or for example they are coupled with a direct optical end node which reaches the building). This can be easily done with various modulation methods, so that if for example the modem communicates with the optical end node at 3 Gigabit per second (preferably by using frequencies above 860 Mhz), this means that up to 30 computers can be supported in each building at a speed of 100 Mbit per second for each computer. If even faster speeds are needed and/or for example there are more computers in the building then this can be solved for example by using even more powerful modulation methods, such as for example using QAM at these high frequencies (and/or for example methods similar to the DMT Discrete Multi-Tone which is used in VDSL modems, but preferably much more efficient since this is coax cable), which can enable the modem to reach even for example a speed of 30 Gigabit per second, or for example one or more optic fibers can be added between the optical end node and the building. However, since typically there are currently up to 250 users which share the same coax cable to the Cable companies Optical End node (which typically serves around 2000 apartments) (which means that on average about 8-10 buildings share the same cable), preferably (unless a separate coax cable is added for each building—but in that case it would be cheaper to add already direct fibers to each building or even directly to each apartment) each building has preferably only one modem of up to for example 3 Gbps, and these 8-10 modems preferably use time sharing over the shared coax and/or for example use separate frequencies, and/or for example the building's modem can indeed go up to higher speeds (for example 30 Gbps or other speeds that are beyond the normal share of the building) and the sharing between the buildings is for example preferably based on TCP/IP packet switching at least for the downlink, so that when some buildings use less than their maximum allowed share other buildings can reach even higher speeds, and/or for example the sharing for the down link is based on sending the same data to all the modems which are sharing the same coax cable like in individual Cable TV modems. Preferably the up-shifter and down-shifter only need simple electronics, so typically they can cost for example around 50 cents each, so the production cost of each Ethernet end-socket can be for example around $2-4 including the TV socket. If even higher speeds per end node (i.e. per individual computer) are covered—for example up to 1 Gbit/second or more per computer and for example the computer uses a 1 Gbit per second Ethernet card or more instead of the normal 100 Mbit card then preferably the Ethernet cards are improved so that they can modulate more data within the 100 Mbit frequency (preferably by using additional parameters for encoding the data and/or for example by using a larger frequency bandwidth), and/or for example the up-shifters and down-shifters are preferably improved similarly, preferably by using additional parameters for encoding the data so that more data can be sent in the same bandwidth, and/or for example preferably a separate coax cable is installed in each room (or at least in some of the rooms), so that preferably they all connect to the router. In order to save costs preferably the up-shifters and down-shifters are designed so that they don't themselves have to do the actual encoding with additional parameters but preferably simply keep the existing additional encoding (or for example keep some of the additional encoding and add some), so that for example if the encoding takes into account the shape of the rising data bit and/or the shape of the declining data bit then preferably these parameters are kept also through the conversion. However, since the current standard of 1000 Base-T 1-Gbps Ethernet uses all four twisted pairs of the Category 5 (or higher) cable to create four 250 Mbps channels (together with an improved encoding scheme—5 level PAM, which means 5-level pulse amplitude modulation, so that the signals stay within the 100 MHz bandwidth rating of CAT5 cabling), preferably in order to be able to work with 1 Gbps Ethernet cards of the current standard and still provide for example at least 5 or even 10 different available frequencies for the Ethernet end-sockets so that they don't interfere with each other over the Coax cable, preferably in such networks preferably the improved up-shifter and down-shifters are preferably able to keeps the for example 5 levels of the amplitude when up-shifting and down-shifting the data. In addition, preferably they can also add at least 1 more encoding parameter (for example the shape of start of the data bit and/or the decline of the data bit) so that the 4 channels can still be sent for example on the same 200 MB range. This can increase their cost for example to about $2 instead of around 50 cents each, but still the solution is relatively cheap. Another possible variation is that Ethernet cards are improved to use some level of QAMM for reaching even higher speeds and preferably the up-shifters and down-shifters are improved so that they keep these parameters when making the shift. However, there is another problem—that in many buildings for example in Israel the currently existing Coax cable configuration is so that there is typically one coax for each floor which is split between the apartments of that floor. This means that in order for the above solution to work preferably additional coax cables are added so that each apartment preferably has at least one separate coax cable from the building coax switchboard, but this means that if there are for example 20 apartments then 20 coax cables need to go up from the 1^{st} floor, which means having to drill new channels in the walls of the stairway or adding for example an external plastic canal. Another possible variation is for example to change the coax cable and preferably also the splitters to more expensive cable capable of working at higher Gbps—for example even 10 Gbps or more, and then preferably no or only a few additional coax cables need to be added, and in this case preferably additional frequency down-shifters and up-shifters are used so that preferably for example up to 50 frequency channels or more (instead of for example 5-6) are preferably available on each coax cable that goes through the stairway, and preferably at the entrance to each apartment appropriate down-shifters and up-shifters are added so that the shifted Ethernet frequencies continue to use preferably just the 2^{nd} Giga in the apartment (unless for example the coax cable is changed also in the apartment itself, in which case different frequency shifters are preferably simply used at the end sockets, however that would be much more expensive since it involves digging in the walls in the apartment). Another possible variation is to add for example optic fibers to each apartment for example from the shared building unit (which is preferably for example at the first floor) (which is still cheaper than digging in the street and adding optic fiber from the Cable company's optical end node to the building) and then preferably the optic end node at the entrance to the apartment is preferably shared between computers within the apartment through the cheap coax home network, however, this is still more expensive than the above described solutions. Another possible variation is that for example instead of adding or changing coax cables in the buildings when needed, the ISP preferably supplies individual apartments for example with a much faster Cable modem (which preferably contains also an integrated router and/or hub preferably with Ethernet connectors for the home network) which uses for example a wider bandwidth channel (for example 10-60 MHz or even more instead of 6 Mhz, or other reasonable number) so that preferably for example with 256 QAM the modem can preferably for example reach up to 380 Mbps or even more instead of 38, and in addition preferably this modem can be remotely configured by the ISP preferably for example for various frequency bands over the 860 MHz (for example any 60 MHz band between 860-1200 Mhz or other reasonable range), so that preferably as more bandwidth is needed the ISP can divide the for example typical 150-250 users who share the same line into subgroups, so that the modems in each sub-group use for example a different for example 60 Mhz band (or other reasonable size of band). This modem is then preferably shared by the computers in the apartment for example by the above described home network. Another possible variation is for example, in addition or instead, also to add a higher QAM ratio above 256 QAM (for example 512 QAM or 1024 QAM or 2048 or 4096 QAM) and/or additional coding parameters to such modems and/or for example to the shared building modems. Another possible variation is that preferably for example for HDTV VOD preferably there is part of the bandwidth which is logically assigned as higher priority for it, which means that preferably such packets have higher priority than other Internet data packets until the maximum allotted bandwidth for this is reached. However the HDTV (preferably both VOD and normal broadcasts) is preferably broadcast with Mpeg 4 compression or similar compressions so that it does not take much more bandwidth than current normal resolution broadcasts which use Mpeg2). Of course various combinations of the above and other variations can also be used.

Preferably the shared building router or routers can also be programmed from afar for example by the ISP, so that preferably users can preferably dynamically preferably instantly change internet definitions preferably without any need for hardware configuration changes in the apartment or in the building, so that for example the users in some apartment can dynamically change for example the sharing relations (i.e. for example the configuration and/or the ratios) between the computers in the apartment for example from a single Internet connection shared by 3 computers in the apartment for example to 2 Internet connections, one alone and one shared by 2 computers or to 3 separate connections, or vice versa—converting separate connections into a single shared connection, and/or for example dynamically change the uplink and/or downlink definitions of each Internet connection. So for example for changing these sharing relations and/or the uplink and/or downlink of each defined connection preferably the relevant multi-apartment router simply changes definitions of how much up and down bandwidth is available for each logical connection and how much is shared between which computers in the relevant apartment, and preferably enforces it for example by treating packets to or from these sharing computers (except for example packets of direct communication between these computers) like packets that go to or from the same IP address for bandwidth limitation purposes (eventhough each of the computers sharing the same Internet connection has a separate IP address). Another possible variation is that for example for changing the sharing relations between computers within the same apartment the users can directly for example change the relevant parameters in the building router without having to make this change through the ISP (for example by a special software which the ISP provides them). (If a separate router is used at the apartment then preferably the sharing relations between the computers in the apartment are controlled by this router and then of course the user can preferably change these sharing relations without needing to contact the ISP). Another possible variation is that preferably such shared connections can also preferably be created or removed for example across separate apartments, however that implementation could be much less desired both by the ISP (since it can mean reduced payments) and by users (since it means depending on the neighbors without knowing how they really intend to use the Internet, so that the users might actually get much less bandwidth than what they expect if for example the neighbor is going to occupy most of the bandwidth most of the time). Another possible variation is that these shared routers of the buildings can also be used for example for communicating directly for example with the electricity meters and/or water meters of apartments (for example by using smart meters which communicate for example through TCP/IP or other methods), and so preferably for example the electricity company or the water authorities can use remote readings instead of having to send someone once in a while to read the meters manually.

Another possible variation is that preferably there are for example only one or a few preferably smart shared set-top boxes for example at the bottom floor of apartment buildings (or for example in a basement) to which preferably all the TV sets in the apartments are connected (for example all to the same one, or for example each such smart set top box can handle up to a certain number of apartments), and preferably in this case each TV within each apartment is preferably for example only connected to a cheaper limited set-top box who's main feature is communicating with the real shared set-top box or boxes of the building (located preferably for example at the bottom floor, preferably coupled to the shared building router or routers described above). In this case preferably the shared building set-top box preferably decodes simultaneously all the relevant channels, by using for example multiple decoders and/or a much stronger CPU or CPUs and/or DSP or DSPs than an ordinary set-top-box, which can preferably decode dozens of channels at the same time (for example up to the number of maximum TV sets supported in building at the same time for example up to 50 or another reasonable number) and preferably sends this data together to all the users who are watching the same channel at the same time. But since typically many people watch the same most popular channels, and some channels are almost never watched, preferably sufficient channels are covered so that at least most of the time that some user jumps to a channel it will be a channel which is already currently being decoded by the shared super-set top box. Preferably covering for example the most important 50 channels (or other reasonable number) means that for example 95-98% (or other reasonable percent) of the time that some user jumps to a channel it will be a channel which is already currently being decoded by the shared set top box because at least one other neighbor is already watching it or has been watching it and hasn't yet switched to another channel (preferably even if for example he/she turned off his TV—i.e. preferably if there are still available decoding resources a channel continues to be decoded even if the neighbor who was watching it has switched the TV off without changing the channel). This means that this can also be used for instant zapping, so that for example only if the next channel that a user zaps to is not covered then the shared set-box has to start covering it (thus for example taking the normal about 2 seconds delay), and if the channel is already covered preferably the user can start seeing the newly chosen channel instantly. For this preferably the shared set-top box preferably creates for the user who just zapped into this channel preferably instantly for example a new base frame from the current logical frame which is currently being transmitted to the other neighbors who are currently watching the show, and preferably continues to encode the new changes to it until the next shared base-frame is reached, and from that point that user can share the same original bit stream which the other neighbors are sharing. Another possible variation is that for example each of the covered channels is transmitted from the shared set-top box to the TV end nodes which are watching it without mpeg compression, so that preferably every frame is a base frame (which is no problem since typically each node can only watch one channel at the same time, which means that the normal multi-channel data preferably no longer need to be transmitted from the shared set-top box to the individual users, so for example all the frequency range up to 860 MHz is available for this). Since some channels might be for example available only to a user who paid specifically for them preferably the limited set-top-box at each end node also takes care of the permissions management when communicating with the shared set-top-box. However, preferably the set-top-box of each apartment can also sense if the connected TV has been turned off (for example by sensing the frequencies generated by the TV set when it is turned on), so that preferably if more separate channels need to be covered the shared set-top box knows that is can discard first of all channels which are being broadcast to TVs which have actually been turned off. Another possible variation is that the shared set-top also uses heuristic predictions of the next-channel or channels which the user is about to zap to (for example by any of the means described in other applications by one of the present inventors for individual set-top boxes), so that for example when the user is zapping sequentially up or down this is taken into account (so that the next channel in the order is predicted) and/or for example when the user puts a finger over a button of the remote even before pressing it and/or for example presses on the first digit (so that the second or third digit can be predicted for example from his/her viewing statistics/history and/or patterns of switching), and/or taking into account his/her viewing statistics and/or channel history), and/or for example the predicting is activated only when the user takes the remote into his/her hand. Preferably this predicting is done by the personal set-top box in the apartment and/or by the remote control, and in the above configuration preferably the personal set-top box preferably automatically sends an update to the shared set-top box to start decoding the next predicted channel (or channels) if it is not being decoded already and there are sufficient available decoding resources for decoding it. Anyway, if for example 50 channels are simultaneously covered and in most normal apartment buildings this is more than the available TV sets, typically there is no problem at all since there are more decoding resources than TV sets. (In skyscrapers for example preferably more shared set-top boxes are used in this variation).(However the TV can be for example the computer monitor if the user has connected a computer or computer monitor the set-top box.)

In case of independent houses (for example villas) instead of apartment buildings, preferably similar solutions are used, except that instead of a central router or routers at the bottom of the building this sharing is preferably done for example in street boxes or cabinets which are preferably secured within strong metal case, each servicing preferably for example up to 10-20 houses around it, or for example as many as can fit at a radius of for example about 100 meters around the box (or other reasonable distance), and/or better cables are is used if bigger distances need to be covered. Similar solutions can preferably used also if the users or some of them are for example satellite subscribers, since in case of satellite broadcasts typically similar coax cables are used. However, since satellite coax cables typically transmit the TV broadcasts on 950-2000 MHz (after being downshifted from the satellite frequencies), this means that preferably different frequency shifters are used in this case for the Ethernet channels, so that for example the frequencies below 950 MB are used for the Ethernet channels, or for example the Satellite down-shifters (for example at the satellite dish on the roof) are changed to use frequencies below 850 MHZ like the cable signals. In apartments that are not subscribers of Cable TV or satellite TV and want to connect to the Internet this way, preferably the coax cable is added during the installation, and preferably in this case more Ethernet frequencies are available for such apartments since the up-shifters can use for example also the frequency range which is normally used for the cable TV broadcasts (i.e. typically the frequencies below 860 Mhz).

Another possible variation is that for example Cable TV and/or for example satellite TV suppliers start transmitting for example their TV programs and/or HTDV and/or VOD for example by pulses or modulated pulses and/or UWB over coax and/or use for example QAM of preferably 256 or 512 or 1024 or 2048 or above (or other numbers in between), and this way preferably the broadcasts become much more efficient and for example need much less bandwidth on the coax, thus leaving more room for the Internet bandwidth (which means preferably changing the transmitter on the optical end node which typically serves 2000 people and changing the Set top boxes of the connected users accordingly), and/or for example start transmitting this way or in similar ways the TV and/or HDTV and/or VOD broadcasts to the home together with the Internet access directly on fiber to the home and/or at least to the building when FTTH becomes available, so that the coax is preferably not needed at all—for example in new installations (in this case preferably for example both the set-top-box and the computers connect to the Internet through the same optic fiber modem in the apartment or shared optic fiber modem in the building, and/or for example there is no set top box and one of the computers acts also as set-top box, and/or for example the entire broadcast or for example at least part of it is by IPTV). For example the above can be done at least with HDTV (preferably of course in combination with using MPEG4 or similar formats instead of MPEG2, as explained above) since HDTV anyway needs new set-top-boxes and new standards, so that even if normal TV broadcasts keep backwards compatibility, the HDTV can be changed much more flexibly, and/or for example the HTDV is preferably broadcast directly for example by the Cable TV supplier on a preferably reserved part of the Internet bandwidth.

Another possible variation is for example the opposite of Ethernet over Coax, so that for example in existing Ethernet networks for example TV RF broadcasts can be carried over the Ethernet cables without disturbing the normal Ethernet communications, by using appropriate up-shifters and down-shifters which shift the carrier waves over which analogue or digital TV is normally carried (typically for example a 6 MHz band per digital channel) to frequencies preferably above those used by the Ethernet communications i.e. typically above 100 Mhz). Preferably this is done for example only to the part that interferes, so that for example if the Cable TV uses the frequencies of for example 50-860 MHz then preferably when the RF from the Coax is transferred to the Ethernet cable preferably only for example the band of approximately 50-100 MHz needs to be up-shifted (for example to 860-910 Mhz), since the parts that are already above 100 Mhz are already sufficiently above the Ethernet frequencies, or for example the entire band of for example 50-860 is shifted together since that can be even more simple electronically. This can be used for example for distributing Cable TV or satellite TV to additional rooms which have already Ethernet connection over Ethernet cables without having to install coax in the additional rooms (for transmitting satellite broadcasts it is even easier, since as explained above, satellite coax cables typically transmit the TV broadcasts on 950-2000 MHz, so there is even no need for the shifters), and/or for example for transmitting IPTV broadcasts from a computer connected to the Internet in one room, for example to other computers or to the TV for example in the living room without taking away bandwidth from the normal Ethernet communications (in this case preferably for example the digital IPTV is preferably converted for example into RF broadcast over the higher frequencies of the Ethernet cable. This can be done for example by using the SVGA output in display adapters that have them or adding an appropriate card for that and adding that output to the Ethernet cable with the appropriate shifter or shifters).

Another possible variation is to use for example the normally unused 2 wires in phone cables for example within houses and/or offices (since typically each phone cable contains 4 wires but the phone company uses only 2 of the wires) for creating cheap home computer networks in existing houses and/or offices preferably without having to insert new wires in the walls. Preferably this is done for example by adding at each needed connection point an additional female phone jack on the wall with the other 2 wires connected to it and using for example an adapter which preferably has on one end a normal phone male connector (which preferably connects to said additional female phone jack) and on the other hand preferably for example a normal male Ethernet connector (but preferably with the 2 wires instead of 8, preferably in the appropriate places), so that the male Ethernet connector is preferably inserted for example into an additional Ethernet card in the main computer that is connected to the Web or into a hub or router through which more than one computer can connect to the web, and preferably this uses the fact that an Ethernet card or router with Ethernet connectors can typically automatically adjust to using only 2 wires instead of 8 by reducing the speed accordingly. Another possible variation is that for example if 2 or more phone lines are available, preferably additional sets of the 2 unused wires can preferably be used, preferably with the same connector, so that for example the same connector can be used with up to 8 wires, so that preferably at the side of the Ethernet connector for example 4 or 8 wires are used, and on the other end for example a special male and female connector is installed accordingly depending on the number of available extra wires, and/or for example the connector ends at the phone end with for example 2 or 3 or 4 2-wire connectors so that if more than 2 extra wires are available then for example each 2 wires preferably have an appropriate female socket on the wall and each connector at the phone end can connect to one of them. (In this case preferably the Ethernet card or hub can preferably automatically adapt also for example if there are 4 wires or 6 wires instead of 2 or 8, thus using what is available). (Another possible variation is for example to insert the phone-end of the adapter directly into the phone connector on the wall so that it connects with the 2 secondary wires below the typical plastic cover of the phone outlet of the wall, without an additional external phone connector, but that is less convenient and less aesthetic). This can mean a very cheap home network, however when using only 2 wires the Ethernet speed can typically be only around 5 Mbit/Sec instead of typically 100 Mbit/Sec. Another problem is that for example in Israel when people buy a Cable phone from Hot.net.il, the company typically connects the phone that works with the cable modem through the second set of wires, so as more people start using Cable phones, these 2 additional wires will not be available to be used for the network by simple connection to an Ethernet card or router as described above. Therefore, a more preferable variation is to use HPNA adapters to take advantage also of the additional 2 wires of each available phone line (since they carry data over phone wires without disturbing normal phone conversations or Fax communications), however preferably HPNA adaptors are improved so that they can support for example also 4 or more wires and not only 2, so that for example if only one phone line is available then preferably all the 4 wires can be used preferably by the same HPNA adaptor and if for example 2 or more phone lines are available then preferably the same HPNA adaptor can work for example in parallel with 8 or more wires, etc., thus preferably increasing speed, for example like using a wide road with more available lanes on it. For example when HPNA 3 becomes available in 2007 (which will support around 320 Mbit/Sec on 2 wires), preferably it is improved as explained above, so that for example with 4 wires it preferably can reach 640 Mbit/Sec or more, and with more wires preferably even higher speeds. Another possible variation is that since for example the HPNA 3 adaptor is able to reach a distance of up to 2000 feet and since many times the street phone switchboard near houses is closer than that to the house (and probably later HPNA versions will be even faster and/or work on even greater distances), preferably at least with such distances preferably at least for example when the Internet connection is supplied by the phone company, preferably HPNA connection is used also between the house and the street switchboard instead of having to use also for example an ADSL or VDSL modem. If the distance is bigger then preferably the HPNA adapter can work even with the longer distance at reduced speeds, so that this solution can be used also for longer distances, since for example as long as the speed is faster than VDSL or even ADSL it is still better then having to add an ADSL or VDSL modem. This means of course that preferably the phone company replaces at least some of the mini ADSL or VDSL connectors in the street switchboard to HPNA connectors and/or for example adds next to the existing street switchboard an additional switchboard or for example section that works with HPNA connectors. Another possible variation is that since for example HPNA 3 can work also over Coax lines, preferably at least some of the above described variations of the Building network can be done by using at least partially for example HPNA over Coax instead of the above described devices, and/or for example by using HPNA over existing phone lines. HPNA 3.1 or above is fit for this also because the new HPNA 3.1 specification published November 2006 is indeed able to use different frequencies (called Multispectrum) for separate channels, thus allowing multiple independent connections at the same time. Of course various combinations of the above and other variations can also be used. Another possible variation is that for example the existing phone lines and outlets and/or similarly existing coax lines and/or their outlets can also be used as additional power outlets for low-wattage devices (such as for example cable modems, palm devices, cameras, etc.), which is preferably done for example by adding for example at one or more points in the apartment or office preferably for example a preferably low amperage transformer that brings electricity from the electric power grid to one or more existing phone lines or coax lines which are already installed in the walls, and preferably adding one or more filters that prevent the extra power from existing the office or the apartment, and preferably connecting appropriate preferably low wattage and low voltage electrical outlets near relevant phone or coax outlets. Another possible variation is to create improved Ethernet cards which have more than one input jack, so that the same card can handle more than one connection, thus functioning for example partially like a hub. Another possible variation is that for example at least in installations for example in new buildings and/or for example new installations in existing buildings preferably for example the phone company for example connects for example the street switchboard to the building and/or to the apartments or houses for example with one or more coax cables and/or for example one or more Ethernet cables preferably instead of normal phone line cables, so that for example two of the wires of the Ethernet cable are used for phone conversations and the others are for example additional lines available for data transfer. So for example if a coax cable is used then preferably voice data is for example transmitted over it for example by upshifters and downshifters like for the other data, as explained above, and/or for example the Ethernet over Coax switchboard is for example built at the street switchboard for example instead of or in addition to doing it for example at the first floor of the building, so that, again, preferably no modem is needed in the house or apartment. If for example an Ethernet cable is used then this means that for example if the connection between the apartment and the street switchboard is made for example by HPNA (for example HPNA 3 or above), then preferably for example all 8 wires can be used for this, or for example 2 of the wires are used like in normal telephony and for example 4 wires or the remaining 6 wires can be used for example for direct Ethernet communications and/or for transferring data by other types of modulation (Normal Ethernet cards can for example use the entire 8 wires for full duplex 1 Gbit per second communication or for example or 4 wires for full duplex 100 Mbit/Sec, and preferably the protocol is improved to enable for example efficient utilization of 6 wires for a speed in between these speeds, for example by using 3 wire sin each direction). Another possible variation is that preferably for example a special Ethernet cable is used which contains for example more wires, so that for example 8 wires can be used by standard 1 Gbit/Sec Ethernet cards and the remaining 2 wires can be used for example for normal phone line, and/or for example even for eample two additional wires are used in the cable for supplying for example up to for example 24 volt of electricity which can be used for example for supplying power to various end gadgets of low power consumption in the house, thus saving on the number of electrical outlets needed. Of course similar principles can be used also with other similar or other technologies which might replace or supersede for example Ethernet. This way preferably no modem at all is needed in the house, since preferably the street switchboard contains one or more Ethernet hubs which are preferably connected to the phone company's other switchboards or ISPs preferably for example by one or more optic fibers, and the connection from the street switchboard to the apartment or house is preferably the Ethernet cable directly to an Ethernet card or hub, and preferably the same cable is used also within the house to connect various rooms preferably with multiple outlets, thus preferably building also a home network, so that for example if a 100 MB/Sec or for example 1 Gbit/Sec connection is used, preferably more than one computer in the house can share the same connection, thus building also a home network at the same time, for example by using a hub with a router or for example by connecting one computer to the switchboard for example with one Ethernet card and adding for example to it a second Ethernet card to which the other computers in the house or apartment connect, thus becoming the gateway computer, or for example an improved Ethernet card is used in the gateway computer which preferably has at least two connections, thus preferably containing a hub and/or router in the card itself and saving the need to add an additional Ethernet card to the gateway computer, as explained above. Of course another possible variation is for example to use only for example a standard Ethernet cable for example from the street to the house or apartment and use for example VOIP over the Ethernet connection for voice data, for example at least between the home and the street switchboard. Another possible variation is that for example at least when making new installations preferably for example phone cables and/or for example coax cables and/or for example Ethernet cables are used which preferably come with an additional one or more optic fibers, preferably combined in the same cable in advance, so that for example one of more optic fibers with a preferably thin jacket are for example included together with the metal wires, and/or for example the external plastic jacket of the cable preferably contains within it also one or more optic fibers. This can save space compared to using for example an additional independent optical fiber or fibers cable with its jacket, and so preferably the diameter of the for example phone cable or Ethernet cable or coax cable preferably remains more or less the same but preferably the cable contains also one or more optic fibers, so that for example this optic fiber or fibers can later be used also for example for direct FTTH connections and/or for example for connecting computers in the internal network through optic fiber communication. These variations can be very useful and important for example in a country like India where currently for example only about 10% of the population have a normal phone line but the government intends to connect at least 50 million people to broadband Internet by 2010, since this means that preferably any of the above variations or various combinations of them can be used in order to connect homes to both phones and broadband Internet at approximately the same const that connecting normal phone lines alone would cost, and at the same time also saving by the fact that preferably no modems are needed at the homes. However there is a problem that if for example an Ethernet cable is used to connect between the home and for example the street switchboard, then, unlike the Coax or HPNA solution, a normal Ethernet cable typically has a maximum distance of only 100 meters. So another possible variation is for example to connect the home for example to the street switchboard for example by Ethernet cable, but then for example use preferably high bitrate HPNA (for example HPNA 3 or higher) or similar methods to transfer the data over the wires (preferably for example improved HPNA adapters which as explained above can preferably connect for example to a variable number of wires and preferably can connect for example both to normal phone wires and/or for example to the wires in an Ethernet cable). Another possible variation is for example to use for this improved Ethernet cables that can be used for example on a distance of preferably for example 2000 feet or more, for example by combing principles of Coax and Ethernet cables, such as for example by using an external shielding or improved shielding around the Ethernet cable and/or for example other combinations and/or for example using improved protocols, such as for example some combination of HPNA and Ethernet. Anyway, preferably since the Coax cable and/or Ethernet cable and/or cable which includes also one or more optic fibers preferably integrated within it, preferably is not considerably larger in diameter than a normal phone line cable, preferably it does not require wider canals than the ones used for inserting normal phone lines, and/or even for example existing phone lines can be pulled out of their canal and the above described cable can preferably be inserted in the same canal in its place. In addition, if one or more optic fibers are integrated in the cable, preferably for example within the external for example plastic jacket of the cable (so that the optic fibers are for example inside the jacket itself, for example between two layers of it of, or for example the optic fibers are in the inner side of the cable), preferably the optic fibers are integrated with sufficient slack flexibility, for example in a somewhat spiral pattern, so that for example bending the cable does not create for example tearing stress on the optic fiber or fibers. This has the further advantage that for example pulling the cable also does not create stress for the optic fiber or fibers since the metal wires, which have preferably less slack freedom than the optic fiber of fibers, are the ones that absorb the stress. Another possible variation is that for example Internet communications can be transferred for example through satellite (for example through an existing satellite dish in buildings that have for example satellite TV) and/or for example through one or more additional separate dishes for example on the roof preferably just for Internet, and/or for example dishes or other wireless receivers and/or transmitters (and/or for example free space optical receivers and/or transmitters) that can communicate for example with the street switchboard or for example with an ISP connection which comes for example from another preferably tall building or for example from one or more lighter than air balloons, and preferably this communication is for example transferred to the apartment or house for example on the same coax cable used for example for satellite TV or cable TV or other preferably existing coax, for example by using upshifters and/or downshifters as explained above, and/or for example over phone line cables from said transmitters and/or receivers for example from the roof to the computer or computers, preferably for example through HPNA and/or for example similar technology, and preferably normal phone calls can also be transmitted through said receiver and/or transmitter and from there to the apartment for example over coax or on a phone cable or for example Ethernet cable and/or for example by any of the methods explained above.

As explained also in the clarifications section, any of the above features can also be used independently of any other features of this invention. Of course various combinations of the above or other variations are also possible.

### BRIEF DESCRIPTION OF THE DRAWINGS

FIG. 1 is an illustration of a typical configuration of one or more shared building units, each unit preferably connecting multiple apartments, with preferably one coax cable for each apartment, so that preferably at least 5 separate Ethernet frequencies are preferably used over the same coax cable for each apartment.

FIG. 2 is an illustration of a typical configuration of an apartment connected to the building network or a stand-alone home network of Ethernet over coax cable.

FIG. 3 is an illustration of a typical Ethernet-enhanced TV cable socket which is preferably inserted in each room in the apartment that might need it.

### IMPORTANT CLARIFICATION AND GLOSSARY

Throughout the patent whenever variations or various solutions are mentioned, it is also possible to use combinations of these variations or of elements in them, and when combinations are used, it is also possible to use at least some elements in them separately or in other combinations. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable subcombination. The above rules of course also mean for example that throughout the specification, including the claims, the words “all” or “each”, such as for example “each computer” or for example “each apartment” or “each end node”, or other word combinations that contain the word “each” or similar words, do not mean necessarily all the items but can mean simply individual items in general or some of them, i.e. it can be for example a general rule, but not necessarily without exceptions. All the drawings are just exemplary diagrams. They should not be interpreted as literal positioning, shapes, angles, or sizes of the various elements. When used throughout the text of this patent, including the claims, “IP Address” stands for “Internet Protocol Address”. However, throughout this patent, including the claims, this address is used as a logical concept and does not necessarily depend on a specific implementation, so the concepts of this patent can work with any implementation or kind of target address. Throughout the patent, including the claims, ISP refers to Internet Service Provider, which typically means infrastructure companies that sell to end users the Internet connection. (Although usually there is a separate infrastructure provider—for example Cable TV vs. ADSL—and separate ISP which provides the Internet connection itself, the term ISP throughout this application including the claims can refer to either of them unless stated explicitly otherwise). Where for example the nodes of for example cable TV companies which typically serves 2000 people are mentioned, this is just an example based on typical practices, and of course the number can be different.

### DETAILED DESCRIPTION OF THE PREFERRED EMBODIMENTS

All of the descriptions in this and other sections are intended to be illustrative examples and not limiting.

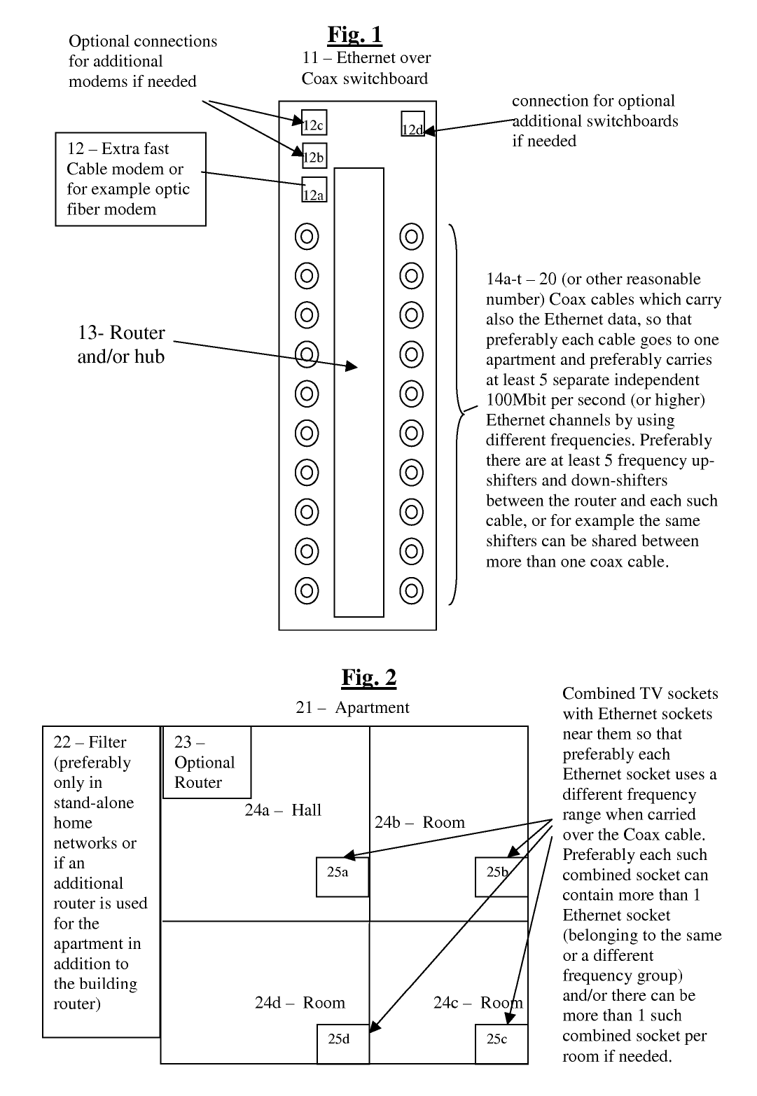

Referring to FIG. 1, we show an illustration of a typical configuration of one or more shared building units (11), each unit preferably connecting multiple apartments, with preferably at least one coax cable (14) for each apartment (in this example there are 20 such coax cables, marked 14a-t, but of course this can be also any other reasonable number), so that preferably for example at least 5 separate Ethernet frequencies are preferably used over the same coax cable preferably for each apartment. Preferably there are for example at least 5 frequency up-shifters and down-shifters between the router and/or hub (13) and each such cable, or for example the same shifters can be shared between more than one coax cables. The shared unit or switchboard (11) preferably connects (for example through connectors 12a-c) to the Internet for example with 1 or more extra fast Cable modems or for example optic fiber modems (12) (or other fast modems or other means), which can preferably work at the speed of at least 1 Gbps, but preferably even 2 Gbps or even 30 Gbps, and preferably similarly high upload speed. Preferably additional units can be cascaded if needed for example through connection 12d like in the Seleste system, or for example each such unit preferably connects to its own fast modem.

Referring to FIG. 2, we show an illustration of a typical configuration of an apartment (21) connected to the above described building network or for example a stand-alone home network of Ethernet over coax cable. Preferably there can be one or more end sockets (25a-d) in each room (or for example some of the socket boxes contain more than one Ethernet end-socket), so that for example a printer or other peripheral devices can also be connected to the same socket in the same room where a computer is also connected to the network. If more than 5 or 6 end sockets are needed in a single apartment then preferably either more than 1 coax cable is connected to that apartment, or for example some of the end devices share the same frequency, which means that at peak load the bandwidth per device might be reduced, but that is no problem since for example 100 Mbit per second is way beyond what most ISPs currently offer users, so even when ISPs start offering for example a 100 Mbit per second internet connection per computer, sharing this for example with a printer will not cause a significant degradation in Internet speed because printing is done only once in a while in short bursts of data transfer and typically with relatively small amounts of data, and/or for example each room (or at least some of the rooms) preferably have a separate coax cable so that for example the coax cables of different rooms preferably all connect to the central hub or router for example at the entrance to the apartment, thus forming for example the shape of a root or tree. Preferably the users can also add for example a socket splitter where needed, which preferably simply plugs into an end node Ethernet socket and converts it into two sockets (preferably still using the same frequency, or for example the additional socket can create an additional shift in the frequency, thus actually becoming a socket of a different frequency). Another possible variation is that for example at least some sockets have a dynamically selectable frequency, for example by using a crystal which can electronically be made to change its frequency, for example by turning a button. Preferably the system allows up to 100 Mbit in full-duplex, preferably by using for example differentiation calculation of the voltages (i.e. preferably by using additive voltages for the transmission), in order to enable signals to be sent in both directions at the same time.

In addition, if the standalone home network variation is used then preferably a filter (22)(or filters) is added, preferably at the point where the coax cable enters the apartment, which preferably prevents the DC current and/or the frequencies of above the normal cable TV broadcasts (typically above 860 MHz) from going outside the apartment. If the integrated building solution is used, then preferably such filters are added between the system at the bottom of the building and the coax cable that enters the building. Another possible variation is to add the additional router (23) in the apartment even in the integrated building solution, so that packets communicating between computers within the apartment don't leave the apartment, since letting internal communications go through the building's routers exposes the user to security risks for example in case someone taps into the lines in the stairway or into the shared routers of the building. In this case preferably the filter of signals above the Cable TV broadcasts is also added at the apartment, which means that preferably only the router of the apartment can enable packets of data on the network to move in or out of the apartment, so that preferably on both sides of this router separate up-shifters and down-shifters are used for each side of the coax cable.

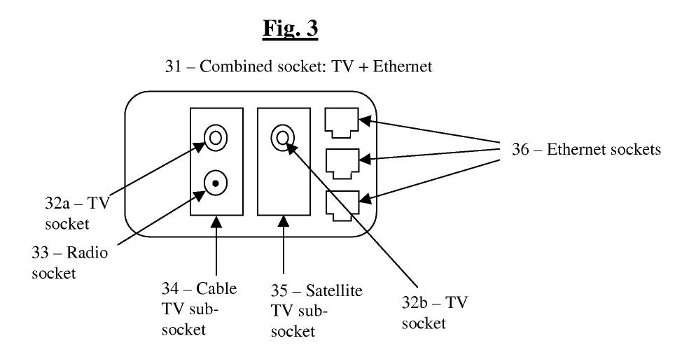

Referring to FIGS. 3, we show a typical Ethernet-enhanced TV cable socket (31) which is preferably inserted in each room in the apartment that might need it. In this example the combined socket contains for example a Cable TV sub-socket (34) and a Satellite sub-socket (35) (each containing a TV socket—32a and 32b respectively), and the Cable sub-socket also contains for example a Radio socket (33), however this is just an example and there might be for example just a Cable TV sub-socket or just a Satellite TV sub-socket or for example no radio socket. In this example there are 3 Ethernet sockets (36), which can be for example each channeled over the Coax on the same frequency or on a different frequency and/or for example he filters are adjustable so that the channel which the Ethernet Socket belongs to can be switched, as explained elsewhere in this application. If additional Ethernet sockets are needed they can preferably for example be added on the other side of the combined socket (the left side in this example). Preferably the “combined” socket can also be for example just with one or more Ethernet sockets based on the Coax, even without a TV socket, if for example no TV connector is needed in that place.

While the invention has been described with respect to a limited number of embodiments, it will be appreciated that many variations, modifications, expansions and other applications of the invention may be made which are included within the scope of the present invention, as would be obvious to those skilled in the art.

We claim:

1. A system of improved computer networking comprising at least one of:
a. An Ethernet over coax system, comprising at least one Coax cable, at least two Ethernet sockets, Filters coupled to each Ethernet socket for shifting up the normal Ethernet frequency in order to send it as data over the Coax and shifting down data received over the coax back into the normal Ethernet frequency, and at least one of: 1. Means for using more than one frequency channel for carrying frequency-shifted Ethernet communications over the Coax, and 2. A home computer network based on Ethernet over Coax, wherein more than one computer shares a modem or optical end unit other internet connection device which is in the apartment though said network;
b. A computer network wherein the normally unused 2 wires in phone cables within houses and/or offices are used for creating cheap home computer networks in existing houses and/or offices;
c. A system of networking wherein at least in installations in new buildings and/or new installations in existing buildings a street switchboard is connected to buildings and/or to the apartments or houses with one or more coax cables and/or one or more Ethernet cables instead of normal phone line cables, and/or phone cables and/or coax cables and/or Ethernet cables are used which come with an additional one or more optic fibers combined in the same cable, and/or through wireless communication which is transferred on existing coax cable, and/or by HPNA or similar technologies over phone line.

2. The system of claim 1 wherein at least one of the following features exists:
a. The Frequency up-shifter shifts Ethernet communications to above the frequency range used by the Cable TV network;
b. There are one or more shared routers and/or hubs at the building which are coupled to at least one high bandwidth modem or optical end unit or other high bandwidth internet connection device and communicate with multiple apartments;
c. There is at least one coax cable per apartment;
d. The shared building router and/or hub takes care of implementing the separate frequency channels by using frequency shifters for each of the needed frequencies.

3. The system of claim 2 wherein at least one of the following features exists:
a. There is such a router and/or hub in each apartment, and all the communications between computers connected to the Ethernet sockets go through this router;
b. Two or more computers in the same apartment can share the same Internet connection and/or can communicated data between themselves;
c. Two or more computers in the same apartment can share the same Internet connection and/or can communicated data between themselves at full Ethernet speeds;
d. There can be one or more end sockets in each room and/or at least one of the socket boxes contain more than one Ethernet end-socket.

4. The system of claim 1 wherein at least one of the following features exists:
a. If more end sockets than the available number of separate frequency channels are needed in a single apartment then more than one coax cable is connected to that apartment, or some of the end devices share the same frequency;
b. The users can also add a socket splitter where needed, which plugs into an end node Ethernet socket and converts it into two sockets, using the same frequency, or the additional socket can create an additional shift in the frequency, thus actually becoming a socket of a different frequency;
c. At least some sockets have a dynamically selectable frequency;
d. At least some sockets have a dynamically selectable frequency by using a crystal which can electronically be made to change its frequency;
e. The system allows up to 100 Mbit in full-duplex by using differentiation calculation of the voltages, in order to enable signals to be sent in both directions at the same time.

5. The system of claim 1 wherein at least one of the following features exists:
a. If one or more shared multi-apartment routers and/or hubs are used in the building then filters and/or multiplexers are added to create a separate coax link for each apartment without cross talks between the apartments;
b. If the solution is implemented as a separate home-network without the shared router at the building, then a filter is added for each apartment;
c. The same coax cable is shared between all the rooms of the apartment;
d. Each room (or at least some of the rooms) have a separate coax cable so that the coax cables of different rooms all connect to the central hub or router.

6. The system of claim 1 wherein at least one of the following features exists:
a. If the solution is implemented as a separate home-network without the shared router at the building, the network uses a hub or router, which is coupled to the Internet modem or a modem is used which contains the router and/or hub within it, or the network is configured so that one of the computers acts as a server;
b. If multiple frequencies are used then if a server is used instead of the router then a separate Ethernet card is added to the server for each frequency, and the Ethernet cards are improved so that a single card can have more than one sockets;
c. If the multiple frequencies are used together with a router in the apartment, the router/hub has sufficient sockets, one for each frequency;
d. If the multiple frequencies are used together with a router in the apartment, the router connects with the filters directly to the Coax cable.

7. The system of claim 1 wherein at least one of the following features exists:
a. The different frequency sockets are sold in different colors, each color for a different frequency, or all sockets are white or similar colors or other common colors and the frequency is marked by a smaller color spot and/or for by other markings and/or by numbers;
b. If some people still prefer the single frequency solution in order to save some installation costs, then different frequencies are distributed to different users, so that if afterwards they decide to upgrade, they can return some of their single frequency sockets and get instead sockets with different frequencies;
c. When the integrated building solution is applied (i.e. the solution with one or more routers which each handle multiple apartments), all the apartments receive the multi-frequency solution, since the cost for the router is already included;
d. When installing an independent home network without the integrated building solution, the installation can either be done by sending a technician to the apartment, which is typically needed anyway if additional coax endpoints need to be added, or the users can install it themselves, especially if there are already sufficient coax TV socket end points.

8. The system of claim 1 wherein at least one of the following features exists:
a. The end sockets are designed in one or more sizes which fit the typical size of most coax end sockets, so that the additional Ethernet socket does not increase the size of the plastic cover of the socket;
b. The improved sockets which include also the Ethernet socket are installed by removing the exiting TV socket and replacing it;
c. The improved sockets which include also the Ethernet socket are installed by adding an element which connects to the given TV and/or radio socket so that only the plastic cover needs to be replaced;
d. The improved sockets which include also the Ethernet socket are installed by plugging a device over the existing TV socket without even having to open its plastic cover.

9. The system of claim 1 wherein at least one of the following features exists:
a. For power supply the frequency up-shifter and down-shifter get their electrical power from the coax cable itself;
b. For power supply the frequency up-shifter and down-shifter get their electrical power from the coax cable itself by adding a DC with a low voltage to the coax cable;
c. If it is a standalone home network then the additional DC is added from a transformer connected to the wall near one of the endpoints so that the DC is carried over also to all the other endpoints by the coax cable;
d. In the integrated building solution the DC is added by a device near the shared router or routers.

10. The system claim 1 wherein at least one of the following features exists:
a. If the users want to be able to use at least one mobile computer in the house, then they can plug into one or more of the end sockets a device which translates the Ethernet communication to wireless communication;
b. Said wireless communication is done by optic wireless communications or by using UWB;
c. If the home network is used without the shared building router and modem then a filter (or filters) is added which prevents the DC current and the frequencies of above the normal cable TV broadcasts from going outside the apartment;
d. If the integrated building solution is used, then filters are added between the system at the bottom of the building and the coax cable that enters the building to prevents the DC current and the frequencies of above the normal cable TV broadcasts from going outside the building.

11. The system of claim 1 wherein at least one of the following features exists:
a. An additional router in the apartment is used even in the integrated building solution, so that packets communicating between computers within the apartment don't leave the apartment;
b. An additional router in the apartment is used even in the integrated building solution, and the filter of signals above the Cable TV broadcasts is also added between the apartment and the rest of the building, and on both sides of this router separate up-shifters and down-shifters are used for each side of the coax cable;
c. Data encryption is automatically added for when computers in the apartments communicate which each other, so that the shared building router can also be used for this communication without the need to add the additional router inside the apartment;
d. If there are additional buildings which share the same coax cable to the Cable company's optical end node, each the modems of the sharing buildings use time sharing over the shared coax or use separate frequencies, and/or the shared building modem can go up to higher speeds and the sharing between the buildings is based on the TCP/IP packet switching at least for the down-link, so that when some buildings use less than their maximum allowed share other buildings can reach even higher speeds, or the sharing for the down link is based on sending the same data to all the modems which are sharing the same coax cable like in individual Cable TV modems;
e. If even higher speeds than 100 Mbps per computer are covered and the computers use Ethernet cards of more than 100 Mbps, the up-shifters and down-shifters are improved for sending more data on the same bandwidth by using additional parameters for encoding the data;
f. If even higher speeds than 100 Mbps per computer are used, in order to save costs the up-shifters and down-shifters are designed so that they don't themselves have to do the actual encoding with additional parameters but keep the existing additional encoding used by the faster Ethernet cards, or keep some of the additional encoding and add some;
g. In buildings in which the currently existing Coax cable configuration is so that the same coax cable is shared between apartments on each floor, additional coax cables are added so that each apartment has at least one separate coax cable from the building coax switchboard;
h. In buildings in which the currently existing Coax cable configuration is so that the same coax cable is shared between apartments on each floor, the coax cable is changed to more expensive cable capable of working for at higher Gbps, so that no or only a few additional coax cables need to be added, and in this case additional frequency down-shifters and up-shifters are used so that more frequency channels are available on each coax cable that goes through the stairway;
i. In buildings in which the currently existing Coax cable configuration is so that the same coax cable is shared between apartments on each floor, optic fibers are added to each apartment from the shared building unit, and then the optic end node at the entrance to the apartment is shared between computers within the apartment through the cheap coax home network;

12. A system of accessing the Internet through cable modems with download bandwidth per computer of more than 50 Mbps wherein the ISP supplies individual apartments with a Cable modem which uses a bandwidth channel of at least 10 MHz instead of the normal 6 MHz, and in addition this modem can be remotely configured by the ISP for various frequency bands over the 860 MHz and/or in other frequencies, so that as more bandwidth is needed the ISP can divide the typical 150-250 users who share the same line into subgroups, so that the modems in each sub-group use a different band.

13. The system of claim 1 wherein at least one of the following features exists:
a. The ISP supplies individual apartments with a Cable modem which uses 512 QAM or higher and/or the shared building modem or modems use 512 QAM or higher;
b. For HDTV VOD there is part of the bandwidth which is logically assigned as higher priority for it, which means that such packets have higher priority than other Internet data packets until the maximum allotted bandwidth for this is reached;
c. The HDTV with VOD and/or in normal broadcasts is broadcast with Mpeg 4 compression or similar compressions so that it does not take much more bandwidth than current normal resolution broadcasts which use Mpeg2;
d. The shared building router or routers can be programmed from afar by the ISP, so that users can dynamically change internet definitions without need for hardware configuration changes in the apartment or in the building, so that the users in some apartment can dynamically change the sharing relations between computers in the apartment, and/or dynamically change the uplink and/or downlink definitions of each Internet connection;
e. These shared routers of the buildings can also be used for communicating directly with the electricity meters and/or water meters of apartments so that the electricity company or the water authorities can use remote readings instead of having to send someone once in a while to read the meters manually.

14. The system of claim 1 wherein there are only one or a few shared set-top boxes at the buildings to which TV sets in the apartments are connected, and TVs in apartments are only connected to a cheaper limited set-top box who's main feature is communicating with the real shared set-top box or boxes of the building, and wherein at least one of the following features exists:
a. Said shared building set-top box decodes simultaneously all the relevant channels, by using multiple decoders and/or a much stronger CPU or CPUs and/or DSP or DSPs than an ordinary set-top-box which can decode dozens of channels at the same time, and sends this data together to all the users who are watching the same channel at the same time;
b. Since typically many people watch the same most popular channels, and some channels are almost never watched, sufficient channels are covered so that at least most of the time that some user jumps to a channel it will be a channel which is already currently being decoded by the shared super-set top box because at least one other neighbor is already watching it or has been watching it and hasn't yet switch to another channel;
c. If there are still available decoding resources a channel continues to be decoded even if the neighbor who was watching it has switched the TV off without changing the channel;
d. This can also be used for instant zapping, so that only if the next channel that a user zaps to is not covered then the shared set-box has to start covering it, and if the channel is already covered the user can start seeing the newly chosen channel instantly;
e. For instant zapping the shared set-top box creates for the user who just zapped into this channel a new base frame from the current logical frame which is currently being transmitted to the other neighbors who are currently watching the show, and continues to encode the new changes to it until the next shared base-frame is reached, and from that point that user can share the same original bit stream which the other neighbors are sharing;
f. Each of the covered channels is transmitted from the shared set-top box to the TV end nodes which are watching it without mpeg compression, so that every frame is a base frame;
g. Since some channels might be available only to user who paid specifically for them the limited set-top-box at each end node also takes care of the permissions management when communicating with the shared set-top-box;
h. The set-top-box of each apartment can also sense if the connected TV has been turned off, so that if more separate channels need to be covered the shared set-top box knows that is can discard first of all channels which are being broadcast to TVs which have actually been turned off;
i. The shared set-top also uses heuristic predictions of the next-channel or channels which the user is about to zap to, and the shared set-top box starts decoding the next predicted channel (or channels) if it is not being decode already and there are sufficient available decoding resources for decoding it.

15. The system of claim 1 wherein at least one of the following features exists:
a. In case of independent houses instead of apartment buildings similar solutions are used, except that instead of a central router or routers at the bottom of the building this sharing is done in street boxes or cabinets, each servicing multiple housed around it;
b. Similar solutions can be used also if the users or some of them are satellite subscribers, since in case of satellite broadcasts typically similar coax cables are used, however, if the satellite coax cables transmit the TV broadcasts at a different frequency range, different frequency shifters are used in this case for the Ethernet channels, or the Satellite down-shifters are changed to use frequencies like the cable signals;
c. In apartments that are not subscribers of Cable TV or satellite TV and want to connect to the Internet this way, the coax cable is added during the installation, and in this case more Ethernet frequencies are available for such apartments since the up-shifters can use also the frequency range which is normally used for the cable TV broadcasts.

16. The system of claim 1 wherein at least one of the following features exists:
a. The Cable TV and/or satellite TV suppliers transmit their TV programs and/or HTDV and/or VOD by pulses or modulated pulses and/or UWB over coax and/or use QAM so that broadcasts become much more efficient and for need less bandwidth on the coax, thus leaving more room for the Internet bandwidth;
b. The Cable TV and/or satellite TV suppliers transmit their TV programs and/or HTDV and/or VOD to the home together with the Internet access directly on fiber to the home when FTTH becomes available, so that the coax is not needed at all;
c. The Cable TV and/or satellite TV suppliers transmit their TV programs and/or HTDV and/or VOD to the home together with the Internet access directly on fiber to the home or to the building, and both the set-top-box and the computers connect to the Internet through the same optic fiber modem in the apartment or shared optic fiber modem in the building, and/or there is no set top box and one of the computers acts also as set-top box.

17. The system of claim 1 wherein the normally unused 2 wires in phone cables within houses and/or offices are used for creating cheap home computer networks in existing houses and/or offices, and at least one of the following features exists:
a. At needed connection points an additional female phone jack is added on the wall with the other 2 wires connected to so that it connects to an adapter which has on one end a normal phone male connector and on the other hand a normal male Ethernet connector, so that the male Ethernet connector can be inserted into an additional Ethernet card in the main computer that is connected to the Web or into a hub or router through which more than one computer can connect to the web, so that the Ethernet card or router with Ethernet connectors can automatically adjust to using only 2 wires instead of 8 by reducing the speed accordingly;
b. If 2 or more phone lines are available, additional sets of the 2 unused wires can preferably be used with the same connector, so that the same connector can be used with up to 8 wires at least at the Ethernet side;
c. Improved HPNA adapters are used which can take advantage also of the additional 2 wires of each available phone line and/or also of additional lines or wires;

18. A system of networking wherein at least when the street switchboard is close enough to the house or office, at least when the Internet connection is supplied by the phone company, HPNA connection is used also between the house and the street switchboard instead of having to use also an ADSL or VDSL modem.

19. The system of claim 17 wherein at least one of the following features exists:
a. The Building network can be done at least partially by using HPNA over Coax and/or by using HPNA over existing phone lines;
b. The existing phone lines and outlets and/or similarly existing coax lines and their outlets can also be used as additional power outlets for low-wattage devices, by adding at one or more points in the apartment or office a transformer that brings electricity from the electric power grid to one or more existing phone lines or coax lines which are already installed in the walls;
c. One or more filters that prevent the extra power from existing the office or the apartment are added and appropriate electrical outlets near relevant phone or coax outlets are added.

20. The system of claim 1 wherein at least in installations in new buildings and/or new installations in existing buildings a street switchboard is connected to buildings and/or to the apartments or houses with one or more coax cables and/or one or more Ethernet cables instead of normal phone line cables, and/or phone cables and/or coax cables and/or Ethernet cables are used which come with an additional one or more optic fibers combined in the same cable, and/or through wireless communication which is transferred on existing coax cable, and/or by HPNA or similar technologies over phone line, and at least one of the following features exists:
a. Two of the wires of the Ethernet cable are used for phone conversations and the others are additional lines available for data transfer;
b. A coax cable is used and voice data is transmitted over it by upshifters and downshifters like for the other data, and/or the Ethernet over Coax switchboard is built at the street switchboard for of or in addition to doing it at the building, so that no modem is needed in the house or apartment;
c. An Ethernet cable is used from the street to the house or apartment and VOIP over the Ethernet connection is used for voice data at least between the home and the street switchboard;
d. An Ethernet cable is used and the connection between the apartment and the street switchboard is made by HPNA;
e. A special Ethernet cable is used which contains more wires, so that sufficient wires can be used for Ethernet communication and separate wires can be used for normal phone line, and/or additional wires are used in the cable for supplying electricity for supplying power to various end gadgets of low power consumption in the house;
f. The street switchboard contains one or more Ethernet hubs which are connected to the apartment or house with an Ethernet cable, and the same cable is used also within the house to create a home network so that more than one computer in the house can share the same connection;
g. Phone cables and/or coax cables and/or Ethernet cables are used which come with an additional one or more optic fibers combined in the same cable;
h. Improved Ethernet cables are used that can be used on larger distance by combing principles of Coax and Ethernet cables and/or using a combination of HPNA and Ethernet and/or other improved protocols;
i. The Coax cable and/or Ethernet cable and/or cable which includes also one or more optic fibers within it is not considerably larger in diameter than a normal phone line cable, so it does not require wider canals than the ones used for inserting normal phone lines, and/or even existing phone lines can be pulled out of their canal and the above described cable can be inserted in the same canal in its place;
j. If one or more optic fibers are integrated in the cable, the optic fibers are integrated with sufficient slack flexibility, so that bending the cable does not create tearing stress on the optic fiber or fibers, and/or pulling the cable does not create stress for the optic fiber or fibers since the metal wires have less slack freedom than the optic fiber of fibers and are the ones that absorb the stress;
k. Internet communications are transferred through satellite and/or through one or more additional separate dishes and/or other wireless receivers and/or transmitters and/or free space optical receivers and/or transmitters, and this communication is transferred from there to the apartment or house on the same coax cable used for example for satellite TV, for example by using upshifters and/or downshifters, and/or over phone line cables from said transmitters and/or receivers to the computer or computers through HPNA and/or similar technology;
l. Internet communications are transferred through satellite and/or through one or more additional separate dishes and/or other wireless receivers and/or transmitters and/or free space optical receivers and/or transmitters, and this communication is transferred from there to the apartment or house on the same coax cable used for example for satellite TV, for example by using upshifters and/or downshifters, and/or over phone line cables from said transmitters and/or receivers to the computer or computers through HPNA and/or similar technology, and normal phone calls can also be transmitted through said receiver and/or transmitter and from there to the apartment for over coax or on a phone cable or Ethernet cable and/or any of the methods explained above.
